(19) United States
(12) Patent Application Publication
(10) Pub. No.: US 2006/0285710 A1
(43) Pub. Date: Dec. 21, 2006

(54) Docking station for a portable music player

(76) Inventor: Tom DeVesto, Cotuit, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/455,461

(22) Filed: Jun. 19, 2006

Related U.S. Application Data
(60) Provisional application No. 60/692,168, filed on Jun. 20, 2005.

(51) Int. Cl. H04R 9/06

(52) U.S. Cl. 381/333

(57) ABSTRACT

A docking station for a portable music player is presented. The docking station includes a base unit having a concealable port capable of providing electrical and mechanical communication with the portable music player. The docking station further includes at least one speaker capable of providing sound received from the portable music player and at least one control for controlling at least one function of base unit and/or the portable music player.

### CROSS REFERENCE TO RELATED APPLICATIONS

The present application claims the benefit of U.S. Provisional Patent Application No. 60/692,168, filed on Jun. 20, 2005, which is incorporated herein by reference.

### BACKGROUND

Portable music players have become ubiquitous. Portable music players, for example the IPOD™ available from Apple Computer, Inc. of Cupertino, Calif. allow for the saving and playing of thousands of songs. The portable music players can be loaded with music from a variety of sources including CDs, files from a music service such as Napster™ or ITunes™, or from a computer. The portable music players are lightweight, easy to use and include headphones to provide personal listening pleasure.

The portable music player may be coupled to a docking station having one or more speakers in order to provide music from the portable music player to one or more listeners, thereby permitting others to enjoy the music.

### SUMMARY

Conventional docking stations, such as those explained above suffer from a variety of deficiencies. One such deficiency is that the port for the portable music player is exposed when not in use, allowing dirt, dust and debris to collect in the port and potentially compromising the interface between the portable music player and the docking station. This can lead to poor performance and decreased reliability of the docking station. Further, this affects the portability of the docking station; for example, taking the docking station outside when the music player is not installed exposes the music player connector to the outside elements.

Embodiments of the invention significantly overcome such deficiencies and provide a docking station for a portable music player that includes a concealable port such that when the port is not in use, the interface to the portable music player is protected from dust, dirt and debris, thereby enhancing the performance and reliability of the docking station.

In a particular embodiment, a docking station for a portable music player includes a base unit having a concealable port capable of providing electrical and mechanical communication with the portable music player. The docking station further includes at least one speaker capable of providing sound received from the portable music player and at least one control for controlling at least one function of base unit and/or the portable music player.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a front view of a particular embodiment of a docking station for a portable music player in accordance with embodiments of the invention;

FIG. 2 illustrates a front view of a particular embodiment of a docking station for a portable music player wherein the music player is connected to the docking station in accordance with embodiments of the invention;

FIG. 3 illustrates a left side view of the docking station for a portable music player of FIG. 1;

FIG. 4 illustrates a rear view of the docking station for a portable music player of FIG. 1;

FIG. 5 illustrates a right side view of the docking station for a portable music player of FIG. 1; and

FIG. 6 illustrates another rear view of the docking station for a portable music player of FIG. 1.

### DETAILED DESCRIPTION

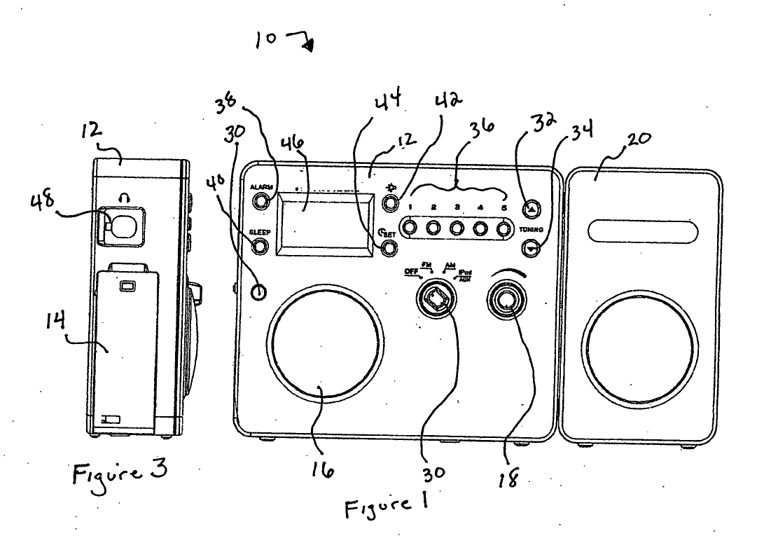

Referring now to FIG. 1, a particular embodiment of a docking station 10 for a portable music player 40 is shown. The docking station 10 comprises a base unit 12 which includes a concealable port capable of providing electrical and mechanical communication with the portable music player.

The base unit 12 further includes at least one speaker 16, the at least one speaker 16 capable of providing sound received from the portable music player. Thus when a portable music player is used, the signal produced by the portable music player is received by way of the concealable port and provided to the base unit 12 such that the signal is provided to the speaker 16 to provide listening enjoyment to one or more persons. The base unit may further include other sound sources including, but not limited to, an AM radio, an FM radio, and an auxiliary port for providing other sound sources (e.g. a walkman or a computer) to be played through the speaker 16.

The base unit 12 further includes at least one control 18 for controlling at least one function of at least one of the base unit 12 and the music player 40. The controls may include, but are not limited to, a volume control, an on/off switch, a source selector, tuning controls, clock controls, station presets and the like. In the example depicted in FIG. 1, the controls include a volume control 18, a source selector 30, tuning controls 32 and 34 and a plurality of radio station presets 36. Also shown are clock controls which include alarm control 38, sleep control 40, clock set control 44 and a display light control 42.

The base unit 12 may further include a display 46 for conveying information to a user. In this example the display 46 shows the current time and which sound source has been selected.

In certain embodiments, at least one detachable speaker 20 is provided. The detachable speaker 20 can be put in communication with the base unit 12 and is capable of providing sound from the portable music player or other selected source. In a preferred embodiment the detachable speaker 20 is the same size as the speaker 16, though other embodiments could include a detachable speaker 20 which is a different size than speaker 16.

The base unit 12 may additionally include a wireless receiver 30 disposed therein. The wireless receiver 30 is capable of receiving wireless signals (e.g., infrared light) from a remote control (not shown) for controlling at least one function of the base unit and/or the music player.

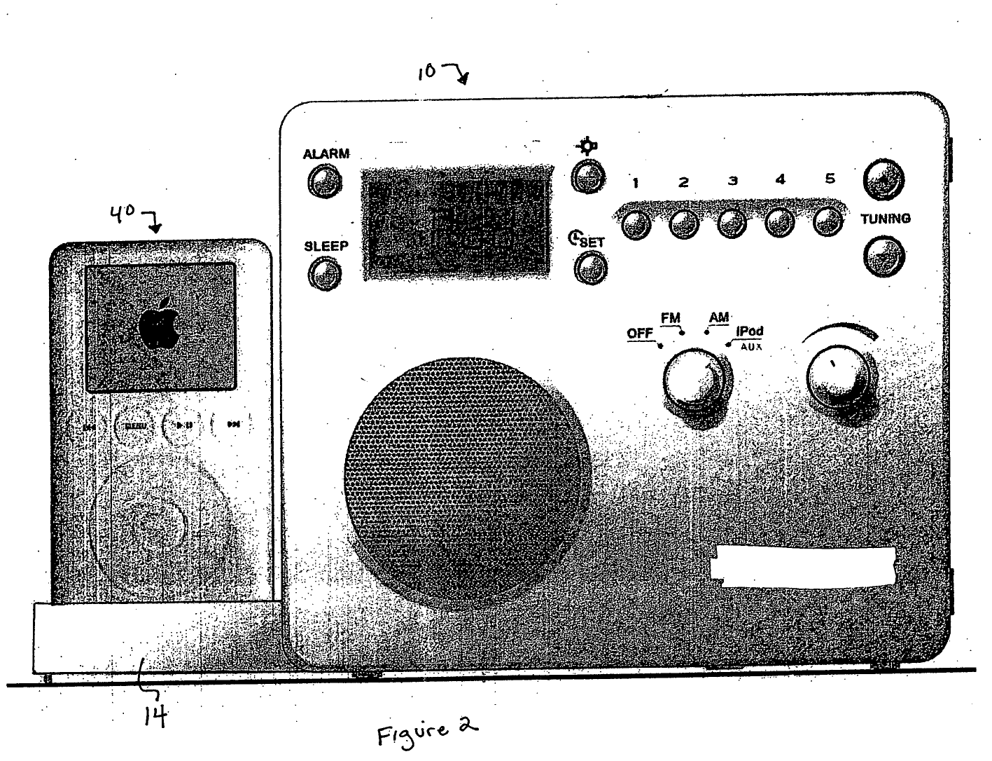

Referring now to FIGS. 2 and 3 the concealable port is shown in both an open position and a closed position. In this particular embodiment, the concealable port includes a hinged arm 14 having a music player connector (not shown) disposed within the hinged arm 14. The hinged arm 14 is disposed within the base unit 12 such that when the concealable port is not in use the hinged arm 14 is positioned within a portion of the base unit 12 such that the music player connector is concealed. This prevents the music player connector from being contaminated when the music player is not installed. Further, by making the hinged arm 14 pivotable into the base unit 12 when not in use, a clean and aesthetically appealing device is presented, as opposed to having a bare connector exposed. In certain embodiments a removable cover can be provided for the music player connector.

When it is desirable to use the concealable port (i.e., a portable music player is to be coupled to the docking station 10) the hinged arm 14 is pivoted extending from the base unit 12 such that the music player is capable of coupling electrically and mechanically to the music player connector of the concealable port. In this manner the music player is supported wherein the music player is not obstructing the front surface of the base unit, thereby none of the speaker(s), the controls, or the display of the base unit 12 are blocked by the music player.

While a hinged arm 14 is used to provide the concealable port in this embodiment, it should be understood that other devices could be used to provide the concealable port, including, but not limited to, a drawer which slides out of the base unit and has the music player connector disposed therein. Further, the location of the concealable port is not limited to the lower left side of the base unit 12. For example, the concealable port could be disposed within a top surface of the base unit 12 and have a slidable or removable cover. Another embodiment of the hinged arm 14 (shown in FIG. 6) provides a portion of the rear surface of the base unit 12. In certain embodiments the music player connector and/or the concealable port may be provided such that the music player is supported at an angle with respect to the base unit 12 such that viewing of a display of the music player is enhanced.

Also shown in FIG. 3 is a headphone jack 48. This jack 48 is used for receiving a headphone plug in order to couple a set of headphones to the docking station 10 such that a signal is provided to the set of headphones in order to provide personal listening to a user.

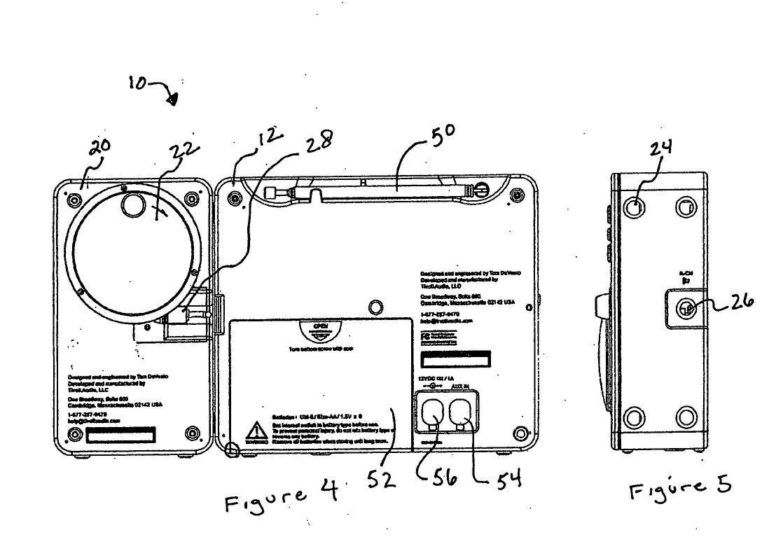

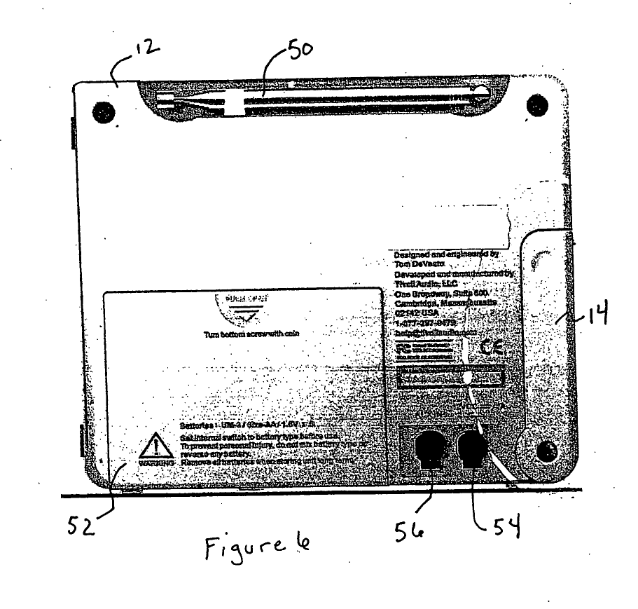

Referring now to FIGS. 4 and 5 the detachable speaker 20 and corresponding connectors 24 and 26 on the base unit 12 are shown. The base unit 12 includes at least one connector 24 (four are used in this example) for mechanically attaching the detachable speaker 20 to the base unit 12. By way of the corresponding mating connectors on the detachable speaker 20, the detachable speaker 20 can be coupled to and transported with the base unit 12. An audio connector 26 is also included in the base unit 12 and is capable of receiving a connector at the end of the speaker wire 28 for providing a signal to the detachable speaker 20. The detachable speaker 20 includes a speaker wire 28 for communication with the base unit 12. The speaker wire 28 may be extendable from the detachable speaker 20 for permitting the detachable speaker 20 to be physically located a distance away from the base unit 12. This provides for placement of the detachable speaker 20 away from the speaker 16, thereby enhancing the listening experience. The detachable speaker 20 may further include a spool 22 for dispensing and retrieving the speaker wire 28. The spool 22 may be operable by a user or may be biased by a spring to provide for speaker wire retrieval when the wire is disconnected from the base unit 12.

Referring now to FIG. 6, a rear view of the base unit 12 is depicted. The base unit 12 includes an auxiliary connector 54, and is usable for connecting an audio source to the base unit 12. The audio source may be realized as a Walkman type device, a computer or similar type device. The docking station 10 may be powered by one or more batteries which are accessible by way of removable cover 52. Additionally, the docking station 10 can receive power from an external power source by way of power connector 56. Also shown is antenna 50 which can be extended and positioned to provide optimal signal reception when the AM or FM radio is selected as the audio source.

In a particular embodiment, the docking station may be provided as a weather-resistant version by implementing stainless steel hardware and sealed cabinets. This improves the usability, reliability and portability of the docking station.

Having described preferred embodiments of the invention it will now become apparent to those of ordinary skill in the art that other embodiments incorporating these concepts may be used. Accordingly, it is submitted that the invention should not be limited to the described embodiments but rather should be limited only by the spirit and scope of the appended claims.

What is claimed is:

1. A docking station for a portable music player comprising:
a base unit including a concealable port capable of providing electrical and mechanical communication with the portable music player;
at least one speaker capable of providing sound received from the portable music player; and
at least one control for controlling at least one function of at least one of said base unit and said music player.

2. The docking station of claim 1 wherein said concealable port comprises a hinged arm and a music player connector disposed within said hinged arm, said hinged arm disposed within said base unit such that when the concealable port is not in use said hinged arm is positioned within a portion of said base unit such that said music player connector is concealed, and when said concealable port is in use said hinged arm is pivoted extending from said base unit such that said music player is capable of coupling electrically and mechanically to said music player connector of said concealable port.

3. The docking station of claim 1 further comprising at least one detachable speaker in communication with said base unit and capable of providing sound received from said portable music player.

4. The docking station of claim 3 wherein said at least one detachable speaker includes at least one detachable speaker connector for receiving a signal from said base unit.

5. The docking station of claim 3 wherein said at least one detachable speaker includes a speaker wire for communication with said base unit, said speaker wire being extendable from said detachable speaker for permitting the detachable speaker to be located a distance away from said base unit.

6. The docking station of claim 5 further comprising a spool located on said detachable speaker for dispensing and retrieving said speaker wire.

7. The docking station of claim 1 further comprising a wireless receiver disposed with said base unit, said wireless receiver capable of receiving wireless signals from a remote control for controlling at least one function of at least one of said base unit and said music player.

8. The docking station of claim 2 wherein said music player connector is disposed within said hinged arm provides support for said music player such that said music player is supported at an angle relative to a front surface of said base unit.

9. The docking station of claim 1 wherein said base unit includes at least one of the group comprising a clock, an AM radio, an FM radio and an auxiliary port.

10. The docking station of claim 2 wherein said hinged arm is capable of extending from a portion of said base unit such that said portable music player is not concealing a front part of said base unit.

11. The docking station of claim 2 further comprising a removable cover for said music player connector.

12. The docking station of claim 2 wherein said base unit is sealed and wherein said music player connector is comprised of stainless steel.

13. The docking station of claim 3 further comprising at least one mechanical connector for removably attaching said detachable speaker to said base unit.

14. The docking station of claim 1 further comprising an internal power source providing power to said base unit.

15. The docking station of claim 1 further comprising a power connector capable of receiving a voltage from an external power source for providing power to said base unit.

16. The docking station of claim 1 further comprising an antenna.

17. The docking station of claim 1 further comprising a display, said display providing information to a user.

18. A docking station for a portable music player comprising:
a base unit including a concealable port capable of providing electrical and mechanical communication with the portable music player, wherein said concealable port comprises a hinged arm and a music player connector disposed within said hinged arm, said hinged arm disposed within said base unit such that when the concealable port is not in use said hinged arm is positioned within a portion of said base unit such that said music player connector is concealed, and when said concealable port is in use said hinged arm is pivoted extending from said base unit such that said music player is capable of coupling electrically and mechanically to said music player connector of said concealable port, wherein said music player connector is disposed within said hinged arm provides support for said music player such that said music player is supported at an angle relative to a front surface of said base unit, wherein said hinged arm is capable of extending from a portion of said base unit such that said portable music player is not concealing a front part of said base unit;
at least one speaker capable of providing sound received from the portable music player;
at least one control for controlling at least one function of at least one of said base unit and said music player;
a wireless receiver disposed with said base unit, said wireless receiver capable of receiving wireless signals from a remote control for controlling at least one function of at least one of said base unit and said music player;
an internal power source providing power to said base unit;
a power connector capable of receiving a voltage from an external power source for providing power to said base unit; and
a display, said display providing information to a user.

19. The docking station of claim 18 further comprising at least one detachable speaker in communication with said base unit and capable of providing sound received from said portable music player, wherein said at least one detachable speaker includes at least one detachable speaker connector for receiving a signal from said base unit, wherein said at least one detachable speaker includes a speaker wire for communication with said base unit, said speaker wire being extendable from said detachable speaker for permitting the detachable speaker to be located a distance away from said base unit, said detachable speaker including a spool located on said detachable speaker for dispensing and retrieving said speaker wire and wherein said base unit includes at least one mechanical connector for removably attaching said detachable speaker to said base unit.

20. The docking station of claim 1 wherein said base unit is sealed and wherein said music player connector, said detachable speaker connector and said at least one mechanical connector are comprised of stainless steel to provide resistance to weather conditions.
